(19) United States
(12) Patent Application Publication
(10) Pub. No.: US 2015/0049001 A1
(43) Pub. Date: Feb. 19, 2015

(54) ENABLING REMOTE SCREEN SHARING IN OPTICAL SEE-THROUGH HEAD MOUNTED DISPLAY WITH AUGMENTED REALITY

(71) Applicant: QUALCOMM Incorporated, San Diego, CA (US)

(72) Inventors: Md Sazzadur RAHMAN, San Diego, CA (US); Martin H. RENSCHLER, San Diego, CA (US); Kexi LIU, San Diego, CA (US)

(73) Assignee: QUALCOMM Incorporated, San Diego, CA (US)

(21) Appl. No.: 14/151,546

(22) Filed: Jan. 9, 2014

Related U.S. Application Data
(60) Provisional application No. 61/867,536, filed on Aug. 19, 2013.

(51) Int. Cl. G02B 27/01

(52) U.S. Cl. CPC G02B 27/017
USPC 345/8

(57) ABSTRACT

A method, an apparatus, and a computer program product construct an augmented view as perceived by a user of an augmented reality (AR) device having an optical see-through head mounted display (HMD) with AR, for display at a remote device. An apparatus obtains scene data corresponding to a real-world scene visible through the optical see-through HMD, and screen data of at least one of a first augmented object displayed on the optical see-through HMD, and a second augmented object displayed on the optical see-through HMD. The apparatus determines to apply at least one of a first offset to the first augmented object relative to an origin of the real-world scene, and a second offset to the second augmented object relative to the origin. The apparatus then generates augmented-view screen data for displaying the augmented view on an HMD remote from the AR device. The augmented-view screen data is based on at least one of the first offset and the second offset.

### CROSS-REFERENCE TO RELATED APPLICATION(S)

This application claims the benefit of U.S. Provisional Application Ser. No. 61/867,536, entitled “Enabling Remote Screen Sharing in Optical See-Through Head Mounted Display with Augmented Reality” and filed on Aug. 19, 2013, which is expressly incorporated by reference herein in its entirety.

### BACKGROUND

1. Field

The present disclosure relates generally to augmented reality (AR) devices, e.g., AR eyeglasses, having optical see-through head mounted displays (HMD), and more particularly, to enabling remote screen sharing using such AR devices. AR is a technology in which a user's view of the real world is enhanced with additional information generated from a computer model. The enhancements may include labels, 3D rendered models, or shading and illumination changes. AR allows a user to work with and examine the physical real world, while receiving additional information about the objects in it.

2. Background

AR devices typically include an optical see-through HMD and one or more user input mechanisms that allow users to simultaneously see and interact with their surroundings while interacting with applications, such as e-mail and media players. User input mechanisms may include one or more of gesture recognition technology, eye tracking technology, and other similar mechanisms.

In optical see-through HMD with AR, virtual objects augment the user's view of real world objects such that both virtual and real-world objects are properly aligned. For example, a person in the field of view of a user may be augmented with her name, an artwork may be augmented with descriptive information, and a book may be augmented with its price.

It may be desirable for a user of an AR device with optical see-through HMD to share what he is seeing through the device, with remote users. To this end, a user's view, including both real world scene and augmented reality, may be captured, transmitted to a remote device over a network, and reconstructed at the remote device in real-time. This capability is beneficial for different use cases such as supervised heating, ventilation, and air conditioning (HVAC) troubleshooting, user interaction research, live demonstration of HMD apps, etc. Such remote observance of users augmented view is referred to herein as “remote screen sharing in HMDs”.

Remote screen sharing in optical see-through HMD is challenging since image data of the user's view are formed in the user's retina as opposed to a video see-through HMD where image data are directly accessible. As such, it is difficult to replicate for remote display, what the user is viewing through their eyes.

### SUMMARY

In an aspect of the disclosure, a method, an apparatus, and a computer program product for constructing an augmented view as perceived by a user of an augmented reality (AR) device having an optical see-through head mounted display (HMD) with AR, for display at a remote device are provided. An apparatus obtains scene data corresponding to a real-world scene visible through the optical see-through HMD, and screen data of at least one of a first augmented object displayed on the optical see-through HMD, and a second augmented object displayed on the optical see-through HMD. The apparatus determines to apply at least one of a first offset to the first augmented object relative to an origin of the real-world scene, and a second offset to the second augmented object relative to the origin. The apparatus then generates augmented-view screen data for displaying the augmented view on an HMD remote from the AR device. The augmented-view screen data is based on at least one of the first offset and the second offset.

### BRIEF DESCRIPTION OF THE DRAWINGS

FIG. 1 is a diagram illustrating an architecture for remote sharing of image data corresponding to a user's view visible through an AR device having an optical see-through HMD.

FIG. 2 is an illustration of an AR device in the form of a pair of eyeglasses.

FIG. 3 is an illustration of a real-world scene through an optical see-through HMD with augmented reality.

FIG. 4 is a diagram illustrating elements of an AR device.

FIG. 5 is an illustration of an instance of a view seen by a user of an AR device, where the view includes a real-world scene visible through optical see-through HMD, and an augmented reality object displayed aligned with the scene.

FIG. 6A is an illustration of an instance of the real-world scene of FIG. 5 captured by a scene camera of the AR device.

FIG. 6B is an illustration of respective augmented reality objects displayed on the left HMD screen and right HMD screen of the AR device, which when viewed by the user of the AR device form the single augmented reality object of FIG. 5.

FIG. 7 is an illustration of misalignment between the real-world scene of FIG. 6A and the augmented reality objects of FIG. 6B that occurs at a remote location when the respective left and right augmented reality objects of FIG. 6B are superimposed over the real-world scene of FIG. 6A.

FIG. 8 is a flow chart of a method of constructing an augmented view as perceived by a user of an AR device having an optical see-through HMD with AR, for display at a remote device.

FIG. 9 is a diagram illustrating elements of an apparatus that constructs an augmented view as perceived by a user of an AR device having an optical see-through HMD with AR, for display at a remote device.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of remote screen sharing through an AR device having an optical see-through HMD will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

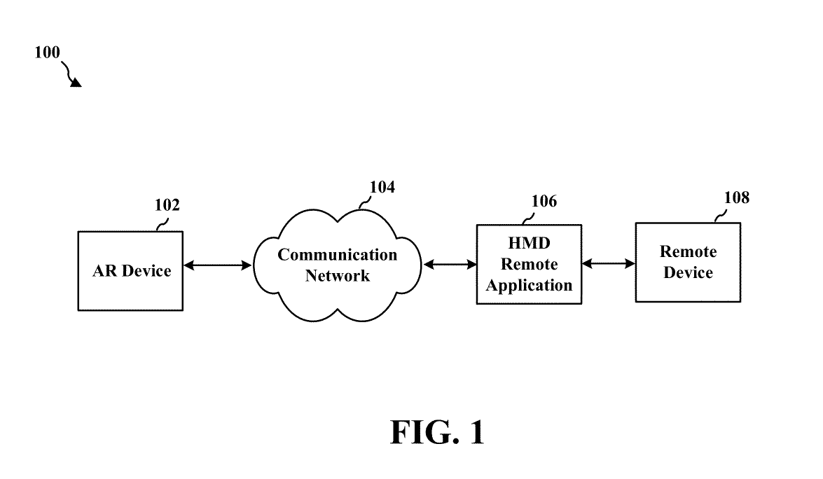

FIG. 1 is a diagram illustrating an architecture for remote sharing of image data corresponding to a user's view visible through an AR device having an optical see-through HMD. The architecture 100 includes an AR device 102, a communications network 104, a HMD remote application 106 and a remote device 108. The AR device 102 generates shared image data corresponding to what a user is seeing both on and through the optical see-through HMD. The AR device 102 transmits the shared image data to the HMD remote application 106 through the communications network 104. The HMD remote application 106, in turn, provides the shared image data to the remote device 108.

“Remote device” as used herein is a device that is separate from the AR device 102 that generated the shared image data. The remote device 108 may be a computer, Smartphones, tablets, laptops, etc. As described above, the HMD remote application 106 receives screen data and scene data from the AR device 102. As described further below, the HMD remote application 106 processes the screen data and the scene data to generate an image corresponding to the image viewed by the user of the AR device 102. The HMD remote application 106 sends the image to the remote device 108. Although the HMD remote application 106 is illustrated as a separate element, the application may be part of the remote device 108.

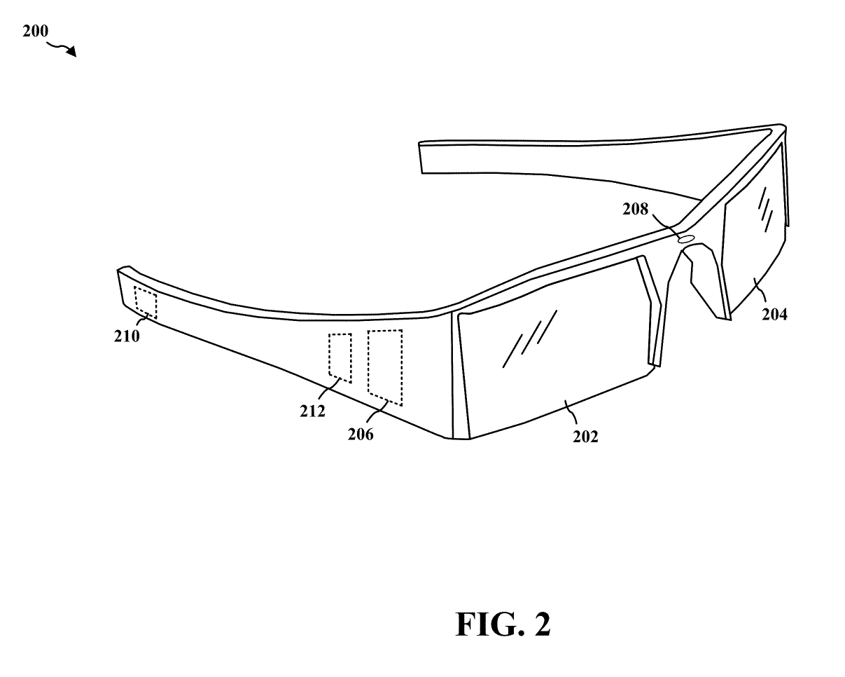

FIG. 2 is an illustration of an example AR device 200 in the form of a pair of eyeglasses. The AR device 200 is configured such that the user of the device is able to view real-world scenes through optical see-through HMDs together with content displayed on the HMDs, including both two-dimensional (2D) and three-dimensional (3D) AR content. The AR device 200 may also be configured to allow the user to interact with the content and possibly with remote devices, systems or networks through wireless communication. The AR device may also provide feedback to the user as a result of such interactions, including for example, audio, video or tactile feedback. To these ends, the example AR device 200 includes a pair of optical see-through HMDs 202, 204, an on-board processing system 206, one or more sensors, such as a scene camera 208, one or more eye tracking components (not visible) for each of the right eye and left eye, one or more user-interaction feedback devices 210 and a transceiver 212.

The processing system 206 and the eye tracking components provide eye tracking capability. Depending on the eye tracking technology being employed, eye tracking components may include one or both of eye cameras and infra-red emitters, e.g. diodes. The processing system 206 and the scene camera 208 provide gesture tracking capability.

The feedback devices 210 provide perception feedback to the user in response to certain interactions with the AR device. Feedback devices 210 may include a speaker or a vibration device. Perception feedback may also be provided by visual indication through the HMD.

The transceiver 212 facilitates wireless communication between the processing system 206 and remote devices, systems or networks. For example, the AR device may communicate with remote servers through the transceiver 212 for purposes of remote processing, such as on-line searches through remote search engines, or remote sharing of image data.

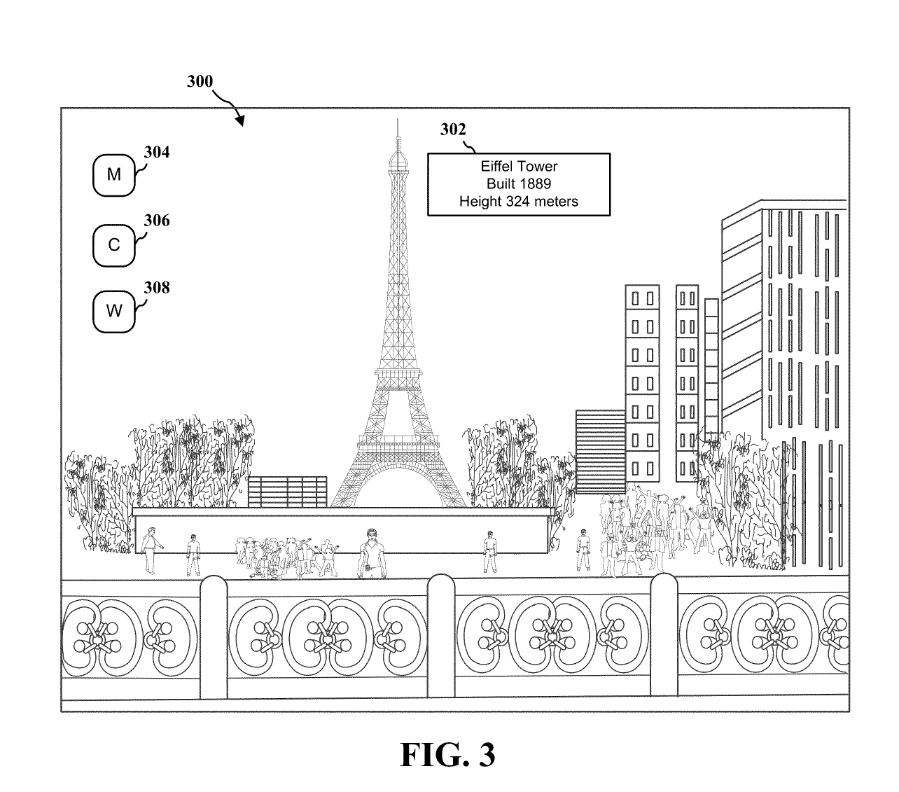

As mention above, the AR device 200 allows a user to view real-world scenes through optical see-through HMDs together with content displayed on the HMDs. For example, with reference to FIG. 3, as a user is viewing a real-world scene 300 through the optical see-through HMDs 202, 204, the scene camera 208 may capture an image of the scene and send the image to the on-board processing system 206. The processing system 206 may process the image and output AR content 302 for display on the HMDs 202, 204. The content 302 may provide information describing what the user is seeing. In some cases, the processing system 206 may transmit the image through the transceiver 212 to a remote processor (not shown) for processing. The processing system 206 may also display one or more application icons 304, 306, 308 on the HMDs 202, 204 and output application content, such as e-mails, documents, web pages, or media content such as video games, movies or electronic books, in response to user interaction with the icons.

User interaction with the AR device 200 is provided by one or more user input mechanisms, such as a gesture tracking module or an eye-gaze tracking module. Gesture tracking is provided by the scene camera 208 in conjunction with a gesture tracking module of the processing system 206. With gesture tracking, a user may attempt to activate an application by placing his finger on an application icon 304, 306, 308 in the field of view of the AR device. The scene camera 208 captures an image of the finger and sends the image to the gesture tracking module. The gesture tracking module processes the image and determines coordinates of a gesture point corresponding to where the user is pointing. The processing system 206 compares the coordinate location of the gesture point to the coordinate location of the icon on the display. If the locations match, or are within a threshold distance of each other, the processing system 206 determines that the user has selected the icon 304, 306, 308 and accordingly, launches the application.

Eye-gaze tracking is provided by the eye tracking components (not visible) in conjunction with an eye tracking module of the processing system 206. A user may attempt to activate an application by gazing at an application icon 304, 306, 308 in the field of view of the AR device. The eye tracking components capture images of the eyes, and provide the images to the eye tracking module. The eye tracking module processes the images and determines coordinates of an eye-gaze point corresponding to where the user is looking The processing system 206 compares the coordinate location of the eye-gaze point to the coordinate location of the icon on the display. If the locations match, or are within a threshold distance of each other, the processing system 206 determines that the user has selected the icon 304, 306, 308 and accordingly, launches the application. Often, such eye-gaze based launching is coupled with another form of input, e.g., gesture, to confirm the user's intention of launching the application.

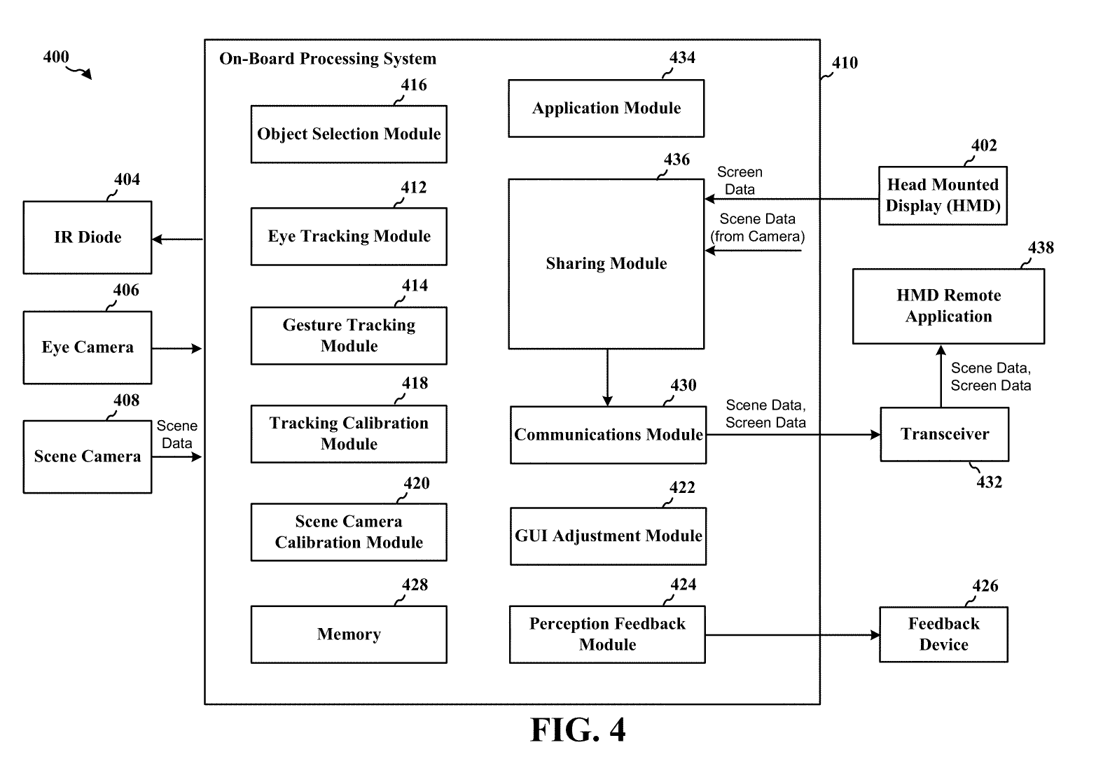

FIG. 4 is a diagram illustrating elements of an example AR device 400 with optical see-through HMDs 402. The AR device 400 may include one or more sensing devices, such as infrared (IR) diodes 404 facing toward the wearer of the AR device and eye cameras 406 facing toward the wearer. A scene camera 408 facing away from the wearer captures images of the field of view seen by the user through the HMD 402. The cameras 406, 408 may be video cameras. While only one IR diode 404 and one eye camera 406 are illustrated, the AR device 400 typically includes several diodes and cameras for each of the left eye and right eye. A single scene camera 408 is usually sufficient. For ease of illustration only one of each sensor type is shown in FIG. 4.

The AR device 400 includes an on-board processing system 410, which in turn includes one or more of an eye tracking module 412 and a gesture tracking module 414. An object selection module 416 processes the outputs of the one or more tracking modules to determine user interactions and tracking module accuracy. A tracking calibration module 418 calibrates the one or more tracking modules if the tracking module is determined to be inaccurate.

The on-board processing system 410 may also include a scene camera calibration module 420, a graphical user interface (GUI) adjustment module 422, a perception feedback module 424, and a sharing module 436. The scene camera calibration module 420 calibrates the AR device so that the AR content is aligned with real world objects. The GUI adjustment module 422 may adjust the parameters of GUI objects displayed on the HMD to compensate for eye-tracking or gesture-tracking inaccuracies detected by the object selection module 416. Such adjustments may precede, supplement, or substitute for the actions of the tracking calibration module 418. The feedback module 424 controls one or more feedback devices 426 to provide perception feedback to the user in response to one or more types of user interactions. For example, the feedback module may command a feedback device 426 to output sound when a user selects an icon in the field of view using a gesture or eye gaze. The sharing module 436 receives scene data from scene camera 408, captures screen data from the HMD 402, and transmits the data to a remote HMD application 438 for further processing as describe in detail below.

The AR device 400 further includes memory 428 for storing program code to implement the foregoing features of the on-board processing system 410. A communications module 430 and transceiver 432 facilitate wireless communications with remote devices, systems and networks.

With further respect to eye tracking capability, the diodes 404 and eye cameras 406, together with the eye tracking module 412, provide eye tracking capability as generally described above. In the example implementation of FIG. 4, the eye tracking capability is based on known infrared technology. One such known technology uses infrared light emitting diodes and infrared sensitive video camera for remotely recording images of the eye. Infrared light output by the diode 404 enters the eye and is absorbed and re-emitted by the retina, thereby causing a “bright eye effect” that makes the pupil brighter than the rest of the eye. The infrared light also gives rise to an even brighter small glint that is formed on the surface of the cornea. The eye tracking module 412 acquires a video image of the eye from the eye camera 406, digitizes it into a matrix of pixels, and then analyzes the matrix to identify the location of the pupil's center relative to the glint's center, as well as a vector between these centers. Based on the determined vector, the eye tracking module 412 outputs eye gaze coordinates defining an eye gaze point (E).

The scene camera 408, together with the gesture tracking module 414, provide gesture tracking capability using a known technology as generally described above. In the example implementation of FIG. 4, the gesture tracking capability is based on gesture images captured by the scene camera 408. The gesture images are processed by the gesture tracking module 414 by comparing captured images to a catalog of images to determine if there is a match. For example, the user may be pointing at an icon in the field of view. The gesture tracking module 412 may detect a match between the gesture image and a cataloged image of pointing and thereby recognize the gesture as pointing. Upon detection of a recognized gesture, the gesture tracking module 414 processes the captured image further to determine the coordinates of a relevant part of the gesture image. In the case of finger pointing, the relevant part of the image may correspond to the tip of the finger. The gesture tracking module 414 outputs gesture coordinates defining a gesture point (G).

The object selection processor 416 functions to determine whether interactions of the user, as characterized by one or more of the eye tracking module 412 and the gesture tracking module 414, correspond to a selection of an object, e.g., application icon, displayed on the HMD 402 and visible in the field of view. If an interaction does correspond to a selection by the user, for example, a selection of an icon to launch an application 434, the object selection processor 416 outputs a command to the application 434.

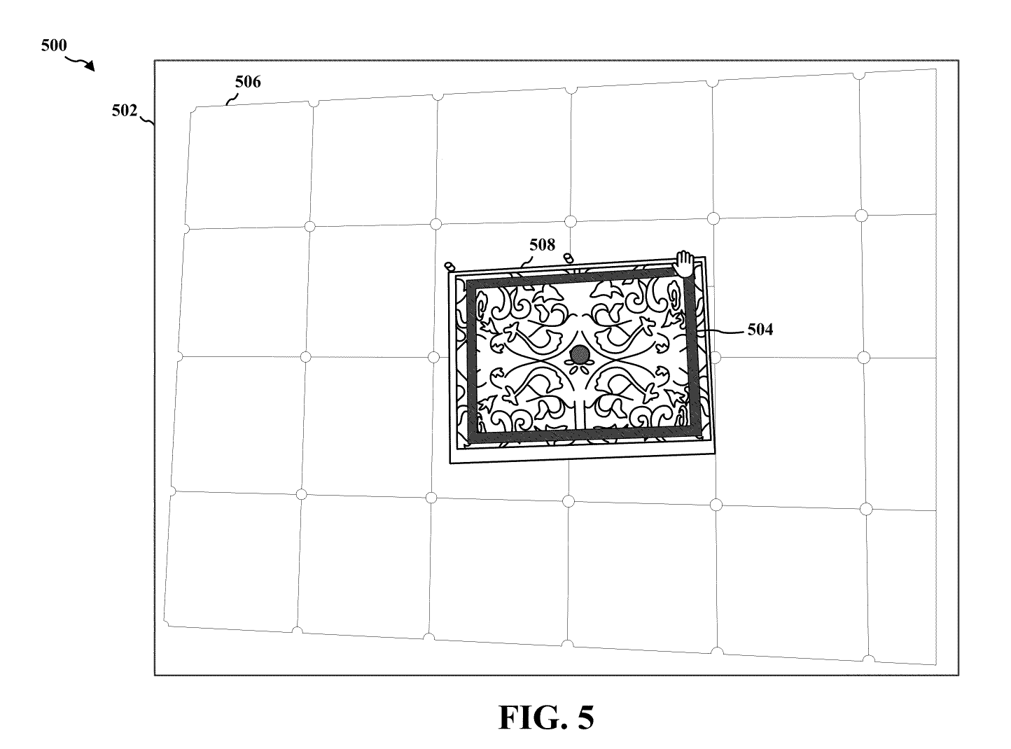

FIG. 5 is an illustration 500 of an instance of an augmented view seen by a user of an AR device, where the view includes a real-world scene 502 visible through an optical see-through HMD, and an augmented reality object 504 displayed over the scene. The real world scene 502 includes a marker artwork 508 that can be tracked by a scene camera for augmentation. The marker artwork 508 is on a wall 506. The augmented reality object 504 is a border around the artwork 508 and a circle in the center. In optical see-through HMD with AR, virtual objects 504 augment the user's view of real world objects 508 such that both virtual and real-world objects are properly aligned.

As previously mentioned, reconstructing the user's view, such as the real world scene together with the augmented object as shown in FIG. 5, remotely in real-time is beneficial for different use cases. For example, such capability allows for remote supervision of work in progress, such as HVAC troubleshooting, joint research by users at remote locations, and remote observations of live demonstration of HMD applications. Remote screen sharing in optical see-through HMD, however, is challenging since image data of user's view are formed in the user's retina as opposed to a video see-through HMD where image data are directly accessible. As such, it is difficult to replicate for remote display, what the user is viewing.

Disclosed herein are methods and apparatuses that enable remote screen sharing in optical see-through HMD by constructing the user's augmented view. “Augmented view” as used herein means the view of the user through the AR device including both the real-world scene as seen by the user and augmented reality objects as also seen by the user. FIG. 5 is an illustration 500 of an instance of an augmented view seen by a user.

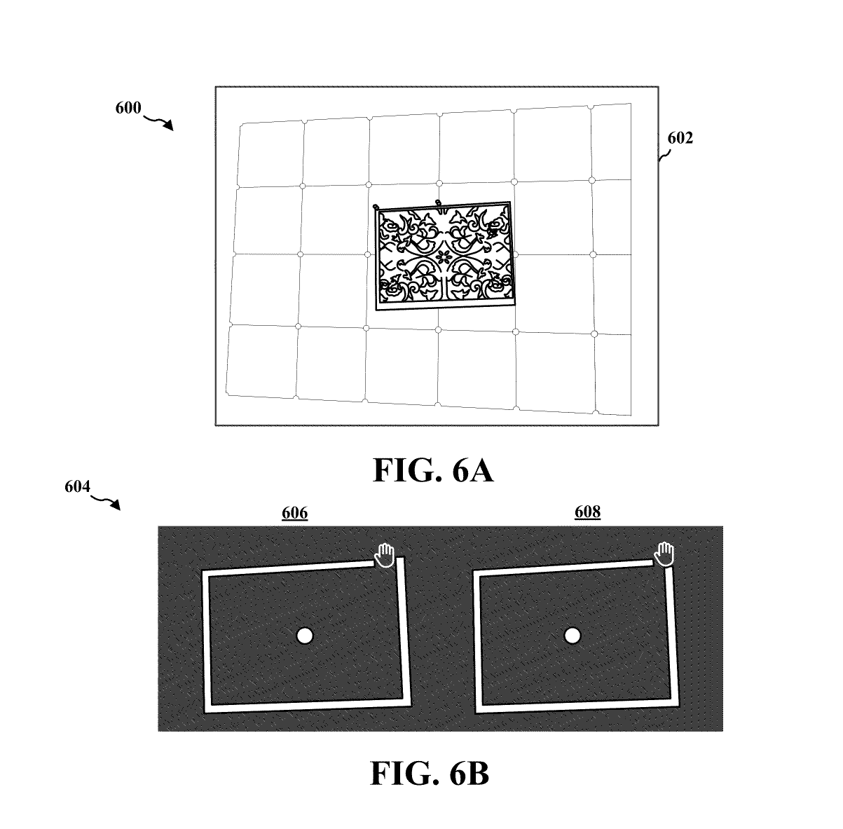

The AR device 410 disclosed herein may enable such remote screen sharing of augmented views. Components of the AR device that facilitate such sharing include the scene camera 408, the HMDs 402, the sharing module 436, and the communication module 430. The scene camera 408 is configured to capture the real world scene component of the augmented view that the user of the AR device is seeing through the optical see-through HMD lens of the glasses. FIG. 6A is an illustration 600 of an instance of a real-world scene 602 captured by a scene camera.

The sharing module 436 includes an HMD screen capture, or screen shot, function that is configured to capture the augmented reality component of the augmented view seen by the user. The augmented reality component includes the augmented reality objects displayed in front of the user on the optical see-through HMDs of the AR device. FIG. 6B is an illustration 604 of respective augmented reality objects displayed on the left HMD screen and right HMD screen of the AR device. The left image 606 corresponds to the augmented reality object displayed on the left optical see-through HMD of the AR device, while the right image 608 corresponds to the augmented reality object displayed on the right optical see-through HMD of the AR device. These objects when viewed by the user of the AR device are perceived as a single augmented reality object, as shown in FIG. 5.

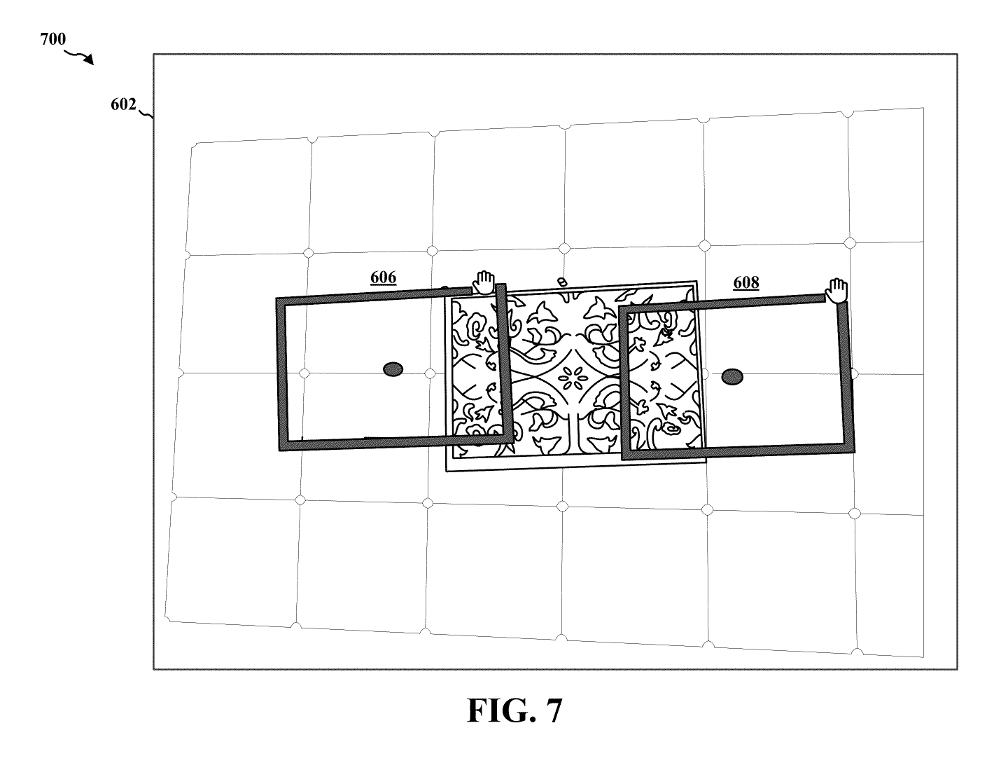

Proper reconstruction of the user's augmented view at a remote device, however, cannot be achieved by simply superimposing screen pixels captured in the HMD screen over scene pixels captured by the scene camera. FIG. 7 is an illustration 700 of misalignment between the real-world scene 602 of FIG. 6A and the augmented reality objects 606, 608 of FIG. 6B that occurs at a remote location when such superimposing is done. The primary reasons for such misalignment are: 1) the scene camera and user's eye positions are different, and 2) the augmented objects are rendered in front of both eyes such that the user wearing the AR glasses perceives the augmented objects stereoscopically aligned with the real world target.

In order to provide accurate remote viewing by others of a user's augment view, methods and apparatuses disclosed herein reconstruct the user's augmented view. More specifically, to adjust this misalignment, methods and apparatuses disclosed herein compute alignment offset for both the left and rights eyes of the user dynamically and then superimpose the adjusted augmentation over the scene image. The disclosed framework takes the following data as input and produces a correct augmented view as an output, such as shown in FIG. 5:

1) Scene camera image, also referred to as scene data (shown in FIG. 6A)

2) HMD screen dump, also referred to as screen data (shown in FIG. 6B)

3) Projection matrix of both eyes (P_{R} and P_{L}) (defines the transformation from scene camera to user's eye) and camera (P_{c})

4) Current modelview matrix M related to the marker (defines the transformation from marker to scene camera)

The above inputs can be sent to a remote HMD remote application 106 over the communications network 104. The remote HMD remote application 106 constructs the user's augmented view using the following algorithm. For ease in description, the screen resolution (Sₓ, S_{y}) and scene resolution (Iₓ, I_{y}) are assumed identical.

```
Input: P_{R}, P_{L}, P_{C}, M, screen_buf, scene_buf
Output: scene_buf
xR, yR, xL, yL = get aligned_offsets (P_{R}, P_{L} , P_{C}, M);
      for y = 0;y<screen_height;y++ do
            for x = 0;x<screen_width;x++ do
                  if (screen buf[x][y]==0) continue; //discarding
            black pixels
                  end
                  if x>screen_width/2 then
                        scene_buf[x + xR][y + yR] =
                        screen_buf[x][y]
            (here, the xR and yR offsets are applied to the x and y
coordinates of the screen pixel (right eye augmented pixel) to
adjust alignment. The augmented pixel (screen buffer) is copied,
or overrides the corresponding pixel in the scene buffer)
                  else
                  scene_buf[x + xL][y + yL] = screen_buf[x][y]
            (here, the xL and yL offsets are applied to the x and y
coordinates of the screen pixel (left eye augmented pixel) to adjust
alignment. The augmented pixel (screen buffer) is copied, or overrides
the corresponding pixel in the scene buffer)
                  end
            end
      end
```

For the inputs, P_{R} is the projection matrix for the right eye, P_{L} is the projection matrix for the left eye, P_{C} is the projection matrix for the scene camera, M is model view matrix, screen_buf is the screen capture from the HMD screen, scene_buf is the scene capture from the scene camera.

The following is code corresponds to line 3 (xR, yR, xL, yL=get aligned offsets(PR, PL, P_{c}, M) of Algorithm 1

```
void get_aligned_offsets( Matrix44F *Pc,
    Matrix
    44F
    *reP,
    Matrix
    44F
    *leP,
    Matrix44F *modelViewMatrix, int Sx, int Sy){
int x0,y0,xr,yr, xl, yl;
convert_from_world_to_screen(Pc, modelViewMatrix, Sx, Sy,
&x0, &y0); convert_from_world_to_screen(reP, modelViewMatrix,
Sx/2, Sy, &xr, &yr); xr+=Sx/2;
convert_from_world_to_screen(leP, modelViewMatrix, Sx/2, Sy, &xl,
&yl);
int xROffset = x0 −xr;
int yROffset = y0 −yr;
int xLOffset = x0 −xl;
int yLOffset = y0 −yl;
}
void convert_from_world_to_screen( Matrix44F *projMatrix,
Matrix44F
*modelViewMatrix,
int Sx, int Sy,
int* X, int* Y){
    V = [0,0,0,1]; //center point on the marker
    Matrix44F C = projMatrix * modelviewMatrix * V;
    Matrix44F Cndc = C/C[3,0];
    //for simplicity, we assume that camera and screen resolution are
    identical
    *X = Cndc[0,0]*Sx/2+Sx/2;
    *Y=(−1)*Cndc[1,0]*Sy/2+Sy/2;
}
```

For the output, scene buffer is the aligned scene output by the algorithm. This buffer will override the input scene buffer.

xR, yR are the aligned offset computed for the right eye. xL, yL are the aligned offset computed for the left eye. The origin for the offsets is the center of the real-world object as provided by the scene camera.

The algorithm scans through each pixel on the screen, e.g., the screen in FIG. 6B, to find what are the non-black pixels. If a pixel is non-black that means it is an augmented pixel, and an offset is applied to the augmented pixel. Once an augmented pixel is identified, the algorithm determines if the pixel is a left eye augmentation or a right eye augmentation. If x is greater than the screen width divided by 2 then it is determined that right eye augmentation is appropriate. If x is not greater than the screen width divided by 2, then left eye augmentation is appropriate.

Once left or right eye augmentation is determined, the proper xR, yR, xL, yL offsets are applied to the corresponding coordinates of the pixel and the augmented pixel is superimposed on the scene image, by overriding the corresponding pixel in the scene buffer with the offset screen image for that pixel. The algorithm scans the screen data by starting at pixel (x, 0) and runs through all values of x. The algorithm then goes to pixel (x, 1) and runs through all values of x and so on.

All inputs vary from user to user, not from HMD remote application to application, thus the framework disclosed herein does not require support from individual HMD remote applications. Projection matrixes and the modelview matrix are globally available in the HDM environment for the user using a HMD. Therefore, this framework can be implemented as a separate service in an HMD environment. This separate service may collect input data, reconstruct the user's augmented view following the above algorithm and send it to the remote HMD remote application 106 over the network 104 for any arbitrary HMD remote application.

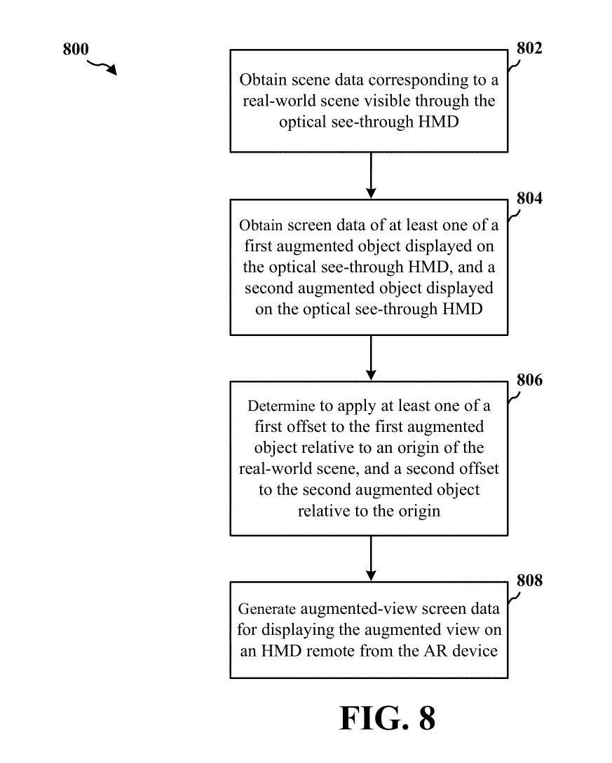

FIG. 8 is a flowchart 800 of a method of constructing an augmented view as perceived by a user of an AR device having an optical see-through HMD with AR, for display at a remote device. The method may be performed by a device remote from the AR device, such as an HMD remote application 438.

At step 802, the remote application 438 obtains scene data corresponding to a real-world scene visible through the optical see-through HMD. The scene data may be obtained from the AR device through which the user is seeing the augmented view. For example, the scene camera of the AR device may capture the real-world scene.

At step 804, the remote application obtains screen data of at least one of a first augmented object displayed on the optical see-through HMD, and a second augmented object displayed on the optical see-through HMD. The screen data may be obtained from the AR device through which the user is seeing the augmented view. For example, a sharing module 436 of the AR device may capture the screen data displayed on the optical see-through HMD.

At step 806, the remote application determines to apply at least one of a first offset to the first augmented object relative to an origin of the real-world scene, and a second offset to the second augmented object relative to the origin. In one configuration, the screen data includes a plurality of pixels and the remote application determines to apply offsets by determining if a pixel is non-black. For a non-black pixel, the remote application then determines if the pixel corresponds to the first augmented object or the second augmented object. If the pixel corresponds to the first augmented object, the remote application applies the first offset to the pixel. If the pixel corresponds to the second augmented object, the remote application applies the second offset if the pixel corresponds to the second augmented object.

The optical see-through HMD may correspond to a right lens of the AR device, in which case the first offset includes an x coordinate offset and a y coordinate offset for the user's right eye. The optical see-through HMD may corresponds to a left lens of the AR device, in which case the second offset includes an x coordinate offset and a y coordinate offset for the user's left eye.

The first offset and the second offset may be respectively based on a first projection matrix and second projection matrix, together with one or more of a scene camera projection matrix defining a transformation from the scene camera to a first eye of the user, and a model view matrix defining a transformation from a marker to the scene camera.

At step 808, the remote application generates augmented-view screen data for displaying the augmented view on an HMD remote from the AR device. The augmented-view screen data is based on at least one of the first offset and the second offset. Generating the augmented-view screen data includes for each offset pixel, replacing the corresponding pixel in the scene data with the offset pixel. In doing so, the image data output by the HMD remote application produces an image on a remote HMD corresponding to the augmented view of the user. In other words, the remote HMD displays the image of FIG. 5 as opposed to FIG. 7.

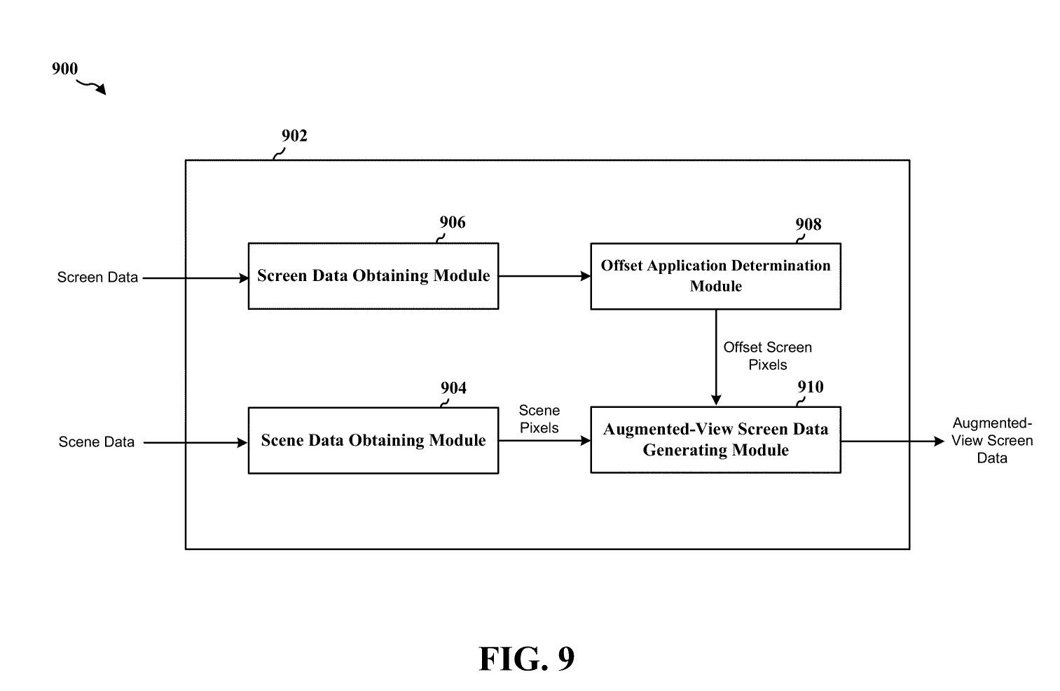

FIG. 9 is a diagram 900 illustrating elements of an apparatus 902, e.g., a HMD remote application, that constructs an augmented view as perceived by a user of an AR device having an optical see-through HMD with AR, for display at a remote device. The apparatus 902 includes a scene data obtaining module 904 that obtains scene data corresponding to a real-world scene visible through the optical see-through HMD, and a screen data obtaining module 906 that obtains screen data of at least one of a first augmented object displayed on the optical see-through HMD, and a second augmented object displayed on the optical see-through HMD.

The apparatus 902 also includes an offset application determination module 908 that determines to apply at least one of a first offset to the first augmented object relative to an origin of the real-world scene, and a second offset to the second augmented object relative to the origin. The apparatus 902 further includes an augmented-view screen data generating module 908 that generates augmented-view screen data for displaying the augmented view on an HMD remote from the AR device. The augmented-view screen data is based on at least one of the first offset and the second offset.

The remote HDM application, as illustrated in FIGS. 4 and 9 may include additional modules that perform each of the steps of the algorithm in the aforementioned flow chart of FIG. 8. As such, each step in the aforementioned flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

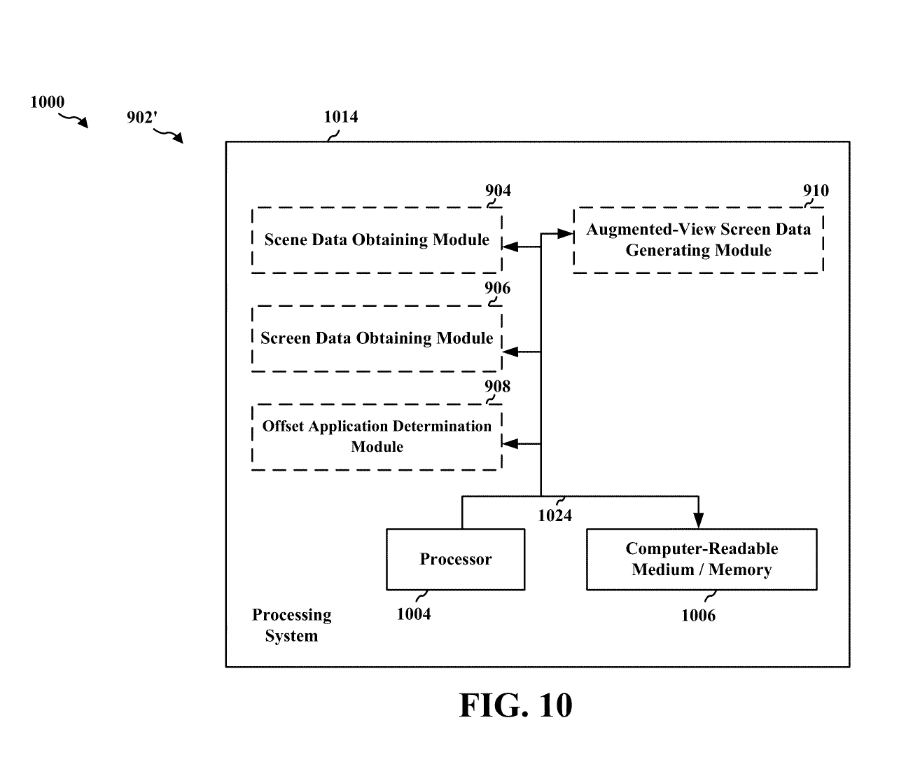

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1004, the modules 904, 906, 908, 910 and the computer-readable medium/memory 1006. The bus 1024 may also link various other circuits such as timing sources, peripherals, voltage regulators, and power management circuits, which are well known in the art, and therefore, will not be described any further.

The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system further includes at least one of the modules 904, 906, 908 and 910. The modules may be software modules running in the processor 1004, resident/stored in the computer readable medium/memory 1006, one or more hardware modules coupled to the processor 1004, or some combination thereof.

In one configuration, the apparatus 902/902′ includes means obtaining scene data corresponding to a real-world scene visible through the optical see-through HMD, means for obtaining screen data of at least one of a first augmented object displayed on the optical see-through HMD, and a second augmented object displayed on the optical see-through HMD, means for determining to apply at least one of a first offset to the first augmented object relative to an origin of the real-world scene, and a second offset to the second augmented object relative to the origin, and means for generating augmented-view screen data for displaying the augmented view on an HMD remote from the AR device, the augmented-view screen data based on at least one of the first offset and the second offset. The aforementioned means may be one or more of the aforementioned modules of the apparatus 902 and/or the processing system 1014 of the apparatus 902′ configured to perform the functions recited by the aforementioned means.

A method of reconstructing a user's view through an optical see-through AR device for display at a remote device includes obtaining data corresponding to a scene image of a real-world object visible through the AR device, obtaining data corresponding to a first screen image of a first augmented object displayed on the AR device, and a second screen image of a second augmented object displayed on the AR device, and determining a first offset for the first screen image relative to an origin provided by the scene image, and a second offset for the second screen image relative to the origin, and generating display data based on the first offset and the second offset, wherein the display data provides a display of the real-world object aligned with the first augmented object and the second augmented object. The first screen image corresponds to the right lens of the AR device and the first offset comprises an x coordinate offset and a y coordinate offset. The second screen image corresponds to the left lens of the AR device and the second offset comprises an x coordinate offset and a y coordinate offset.

A corresponding apparatus for reconstructing a user's view through an optical see-through AR device for display at a remote device includes means for obtaining data corresponding to a scene image of a real-world object visible through the AR device, means for obtaining data corresponding to a first screen image of a first augmented object displayed on the AR device, and a second screen image of a second augmented object displayed on the AR device, means for determining a first offset for the first screen image relative to an origin provided by the scene image, and a second offset for the second screen image relative to the origin, and means for generating display data based on the first offset and the second offset, wherein the display data provides a display of the real-world object aligned with the first augmented object and the second augmented object.

Another apparatus for reconstructing a user's view through an optical see-through an AR device for display at a remote device includes a memory, and at least one processor coupled to the memory and configured to obtain data corresponding to a scene image of a real-world object visible through the AR device, to obtain data corresponding to a first screen image of a first augmented object displayed on the AR device, and a second screen image of a second augmented object displayed on the AR device, to determine a first offset for the first screen image relative to an origin provided by the scene image, and a second offset for the second screen image relative to the origin, and to generate display data based on the first offset and the second offset, wherein the display data provides a display of the real-world object aligned with the first augmented object and the second augmented object.

A computer program product for reconstructing a user's view through an optical see-through AR device for display at a remote device includes a computer-readable medium comprising code for obtaining data corresponding to a scene image of a real-world object visible through the AR device, code for obtaining data corresponding to a first screen image of a first augmented object displayed on the AR device, and a second screen image of a second augmented object displayed on the AR device, code for determining a first offset for the first screen image relative to an origin provided by the scene image, and a second offset for the second screen image relative to the origin, and code for generating display data based on the first offset and the second offset, wherein the display data provides a display of the real-world object aligned with the first augmented object and the second augmented object.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of constructing an augmented view as perceived by a user of an augmented reality (AR) device having an optical see-through head mounted display (HMD) with AR, for display at a remote device, said method comprising:
obtaining scene data corresponding to a real-world scene visible through the optical see-through HMD;
obtaining screen data of at least one of a first augmented object displayed on the optical see-through HMD, and a second augmented object displayed on the optical see-through HMD;
determining to apply at least one of a first offset to the first augmented object relative to an origin of the real-world scene, and a second offset to the second augmented object relative to the origin; and
generating augmented-view screen data for displaying the augmented view on an HMD remote from the AR device, the augmented-view screen data based on at least one of the first offset and the second offset.

2. The method of claim 1, wherein the screen data comprises a plurality of pixels and determining to apply comprises:
determining if a pixel is non-black;
for a non-black pixel, determining if the pixel corresponds to the first augmented object or the second augmented object;
applying the first offset if the pixel corresponds to the first augmented object; and
applying the second offset if the pixel corresponds to the second augmented object.

3. The method of claim 2, wherein generating augmented-view screen data comprises:
for each offset pixel, replacing the corresponding pixel in the scene data with the offset pixel.

4. The method of claim 1, wherein the optical see-through HMD corresponds to a right lens of the AR device and the first offset comprises an x coordinate offset and a y coordinate offset.

5. The method of claim 1, wherein the optical see-through HMD corresponds to a left lens of the AR device and the second offset comprises an x coordinate offset and a y coordinate offset.

6. The method of claim 1, wherein the origin is obtained from a scene camera that captured the scene data.

7. The method of claim 1, wherein the first offset and the second offset are respectively based on a first projection matrix and second projection matrix defining a transformation from the scene camera to a first eye of the user, a scene camera projection matrix, and a model view matrix defining a transformation from a marker to the scene camera.

8. An apparatus for constructing an augmented view as perceived by a user of an augmented reality (AR) device having an optical see-through head mounted display (HMD) with AR, for display at a remote device, said apparatus comprising:
means for obtaining scene data corresponding to a real-world scene visible through the optical see-through HMD;
means for obtaining screen data of at least one of a first augmented object displayed on the optical see-through HMD, and a second augmented object displayed on the optical see-through HMD;
means for determining to apply at least one of a first offset to the first augmented object relative to an origin of the real-world scene, and a second offset to the second augmented object relative to the origin; and
means for generating augmented-view screen data for displaying the augmented view on an HMD remote from the AR device, the augmented-view screen data based on at least one of the first offset and the second offset.

9. The apparatus of claim 8, wherein the screen data comprises a plurality of pixels and the means for determining to apply is configured to:
determine if a pixel is non-black;
for a non-black pixel, determine if the pixel corresponds to the first augmented object or the second augmented object;
apply the first offset if the pixel corresponds to the first augmented object; and
apply the second offset if the pixel corresponds to the second augmented object.

10. The apparatus of claim 9, wherein the means for generating augmented-view screen data is configured to:
for each offset pixel, replace the corresponding pixel in the scene data with the offset pixel.

11. The apparatus of claim 8, wherein the optical see-through HMD corresponds to a right lens of the AR device and the first offset comprises an x coordinate offset and a y coordinate offset.

12. The apparatus of claim 8, wherein the optical see-through HMD corresponds to a left lens of the AR device and the second offset comprises an x coordinate offset and a y coordinate offset.

13. The apparatus of claim 8, wherein the origin is obtained from a scene camera that captured the scene data.

14. The apparatus of claim 8, wherein the first offset and the second offset are respectively based on a first projection matrix and second projection matrix defining a transformation from the scene camera to a first eye of the user, a scene camera projection matrix, and a model view matrix defining a transformation from a marker to the scene camera.

15. An apparatus for constructing an augmented view as perceived by a user of an augmented reality (AR) device having an optical see-through head mounted display (HMD) with AR, for display at a remote device, said apparatus comprising:
a memory; and
at least one processor coupled to the memory and configured to:
obtain scene data corresponding to a real-world scene visible through the optical see-through HMD;
obtain screen data of at least one of a first augmented object displayed on the optical see-through HMD, and a second augmented object displayed on the optical see-through HMD;
determine to apply at least one of a first offset to the first augmented object relative to an origin of the real-world scene, and a second offset to the second augmented object relative to the origin; and
generate augmented-view screen data for displaying the augmented view on an HMD remote from the AR device, the augmented-view screen data based on at least one of the first offset and the second offset.

16. The apparatus of claim 15, wherein the screen data comprises a plurality of pixels and the processor determines to apply by being further configured to:
determine if a pixel is non-black;
for a non-black pixel, determine if the pixel corresponds to the first augmented object or the second augmented object;
apply the first offset if the pixel corresponds to the first augmented object; and
apply the second offset if the pixel corresponds to the second augmented object.

17. The apparatus of claim 16, wherein the processor generates augmented-view screen data by being further configured to:
for each offset pixel, replace the corresponding pixel in the scene data with the offset pixel.

18. The apparatus of claim 15, wherein the optical see-through HMD corresponds to a right lens of the AR device and the first offset comprises an x coordinate offset and a y coordinate offset.

19. The apparatus of claim 15, wherein the optical see-through HMD corresponds to a left lens of the AR device and the second offset comprises an x coordinate offset and a y coordinate offset.

20. The apparatus of claim 15, wherein the origin is obtained from a scene camera that captured the scene data.

21. The apparatus of claim 15, wherein the first offset and the second offset are respectively based on a first projection matrix and second projection matrix defining a transformation from the scene camera to a first eye of the user, a scene camera projection matrix, and a model view matrix defining a transformation from a marker to the scene camera.

22. A computer program product for constructing an augmented view as perceived by a user of an augmented reality (AR) device having an optical see-through head mounted display (HMD) with AR, for display at a remote device, said product comprising:
a computer-readable medium comprising code for:
obtaining scene data corresponding to a real-world scene visible through the optical see-through HMD;
obtaining screen data of at least one of a first augmented object displayed on the optical see-through HMD, and a second augmented object displayed on the optical see-through HMD;
determining to apply at least one of a first offset to the first augmented object relative to an origin of the real-world scene, and a second offset to the second augmented object relative to the origin; and
generating augmented-view screen data for displaying the augmented view on an HMD remote from the AR device, the augmented-view screen data based on at least one of the first offset and the second offset.
